(19) United States
(12) Patent Application Publication
(10) Pub. No.: US 2004/0188456 A1
(43) Pub. Date: Sep. 30, 2004

(54) Medicine supply apparatus, tablet case, and medicine container

(75) Inventors: Takashi Arai, Gunma (JP); Yuichi Tamaoki, Gunma (JP); Manabu Haraguchi, Gunma (JP)

Correspondence Address: DARBY & DARBY P.C., P. O. BOX 5257, NEW YORK, NY, 10150-5257, US

(73) Assignees: Sanyo Electric Co., Ltd., Osaka (JP); Sanyo Electric Biomedical Co., Ltd., Osaka (JP)

(21) Appl. No.: 10/801,396

(22) Filed: Mar. 15, 2004

(30) Foreign Application Priority Data
Mar. 25, 2003 (JP) 2003-083017
Mar. 25, 2003 (JP) 2003-083030

(51) Int. Cl. G07F 11/00; B65H 3/00

(52) U.S. Cl. 221/263

(57) ABSTRACT

There is disclosed a medicine supply apparatus that can effectively prevent the quality of medicines contained in a tablet case from changing due to moisture. The medicine supply apparatus includes a tablet case having an opening, a discharge mechanism for dropping a medicine in the tablet case through the opening so as to be discharged, a drive mechanism for driving the discharge mechanism, and a filling member for receiving the medicine discharged by the discharge mechanism, wherein the opening of the tablet case is closed by a detachable cover member to enable sealing the inside of the tablet case.

### BACKGROUND OF THE INVENTION

The present invention relates to a medicine supply apparatus that supplies medicines (representing any kind of solid medicines such as tablets, capsules, pills, or troches) contained in a tablet case by the quantity specified by a prescription, and further relates to such a tablet case and a medicine container containing such medicines.

In hospitals or pharmacies, a tablet feeder (medicine supply apparatus) has been conventionally used to offer tablets prescribed by a doctor to a patient. In the apparatus, the tablets (medicines) in the quantity described in a prescription are discharged from a discharge drum (alignment board) in a tablet case one by one, then collected by a hopper, a conveyor, or the like, and then packed with medicine packing paper (e.g. see JP-Y-S57-7660).

Generally, the tablet case used in the medicine supply apparatus of this type is open at its upper end, and this upper end opening is openably closed by a cover. Medicines are filled into the tablet case by opening this cover. The foregoing discharge drum (discharge mechanism) is attached in the lower part of the tablet case, and the medicines are discharged by dropping them one by one from a discharge port by an operation of the discharge drum.

That is, the inside of the conventional tablet case is in constant communication with the exterior through the discharge port disposed at its lower end. Further, sealing of the foregoing upper end opening with the cover is not perfect. On the other hand, a tablet case that is not frequently used (e.g. a tablet case containing medicines that are rarely supplied) is kept in the state where it is removed from the medicine supply apparatus, and therefore, there has been a problem that outside moisture enters the tablet case to change the quality of the medicines contained therein.

### SUMMARY OF THE INVENTION

The present invention has been made for solving the foregoing conventional technical problems, and has an object to provide a medicine supply apparatus that can effectively prevent the quality of a medicine contained in a tablet case from changing due to moisture, and to further provide such a tablet case.

It is another object of the present invention to enable the foregoing tablet case to be formed by the use of a medicine container.

A medicine supply apparatus of the present invention comprises a tablet case having an opening, a discharge mechanism for dropping a medicine in the tablet case through the opening so as to be discharged, a drive mechanism for driving the discharge mechanism, and a filling member for receiving the medicine discharged by the discharge mechanism, wherein the opening of the tablet case is closed by a detachable cover member to enable sealing the inside of the tablet case. Therefore, when the tablet case is not used, it is possible to close the opening of the tablet case by the use of the cover member to keep the tablet case while sealing the inside thereof. This makes it possible to effectively prevent the quality of the medicines contained in the tablet case from changing due to moisture.

Further, in the medicine supply apparatus of the present invention, the discharge mechanism is provided within the tablet case, and the drive mechanism drives the discharge mechanism in the state where the tablet case is detachably mounted on a mounting portion. Therefore, it is possible to smoothly discharge the medicine in the tablet case by the discharge mechanism, and receive and supply it by the filling member.

Further, in the medicine supply apparatus of the present invention, the discharge mechanism is detachably mounted in the tablet case. Therefore, upon supplementing medicines into the tablet case through the opening thereof, the medicines can be filled up by removing the discharge mechanism. This makes it possible to easily fill the medicines into the tablet case.

A tablet case of the present invention comprises a medicine containing portion having an opening and containing medicines, a discharge mechanism provided in the medicine containing portion for dropping the medicine in the medicine containing portion through the opening thereof so as to be discharged, and a detachable cover member closing the opening of the medicine containing portion to seal the inside of the medicine containing portion. Therefore, when the tablet case is not used, it is possible to close the opening of the tablet case by the use of the cover member to keep the tablet case while sealing the inside thereof. This makes it possible to effectively prevent the quality of the medicines contained in the tablet case from changing due to moisture.

Further, in the tablet case of the present invention, the discharge mechanism is detachably mounted in the medicine containing portion. Therefore, upon supplementing medicines into the tablet case through the opening thereof, the medicines can be filled up by removing the discharge mechanism. This makes it possible to easily fill the medicines into the tablet case.

A medicine container of the present invention is configured such that a container body containing medicines has an opening that is closed and sealed by a detachable cover member, wherein a discharge mechanism for dropping the medicine contained in the container body through the opening thereof so as to be discharged, can be detachably attached in the container body. Therefore, by forming the tablet case using the medicine container that is, for example, offered to a taker and mounting it onto the mounting portion of the medicine supply apparatus, the medicine in the container body can be discharged by the discharge mechanism. This enables medicine supply without using a particular tablet case.

Since the opening of the container body can be sealed with the cover member, when it is not used, it is possible to effectively prevent the quality of the medicines contained therein from changing due to moisture by closing the opening of the container body using the cover member.

Further, since the opening of the container body can be closed by the cover member in the state where the discharge mechanism is attached, when it is not used, it is possible to seal the inside of the container body with the cover member while the discharge mechanism is attached, and therefore, usage thereof is improved.

### BRIEF DESCRIPTION OF THE DRAWINGS

FIG. 1 is a perspective view of a medicine supply apparatus of the present invention;

FIG. 2 is a see-through perspective view of a tablet case of the present invention;

FIG. 3 is a perspective view of the tablet case of FIG. 2;

FIG. 4 is another see-through perspective view of the tablet case of FIG. 2;

FIG. 5 is a see-through perspective view of a discharge mechanism of the tablet case of FIG. 2;

FIG. 6 is a partly cutaway perspective view of the discharge mechanism of the tablet case of FIG. 2;

FIG. 7 is another partly cutaway perspective view of the discharge mechanism of the tablet case of FIG. 2;

FIG. 8 is an exploded perspective view of the tablet case of FIG. 2;

FIG. 9 is another exploded perspective view of the tablet case of FIG. 2;

FIG. 10 is another perspective view of the medicine supply apparatus of FIG. 1;

FIG. 11 is still another perspective view of the medicine supply apparatus of FIG. 1;

FIG. 12 is yet still another perspective view of the medicine supply apparatus of FIG. 1; and

FIG. 13 is a perspective view illustrating a modification of the medicine supply apparatus of FIG. 1.

### DETAILED DESCRIPTION OF THE PREFERRED EMBODIMENT

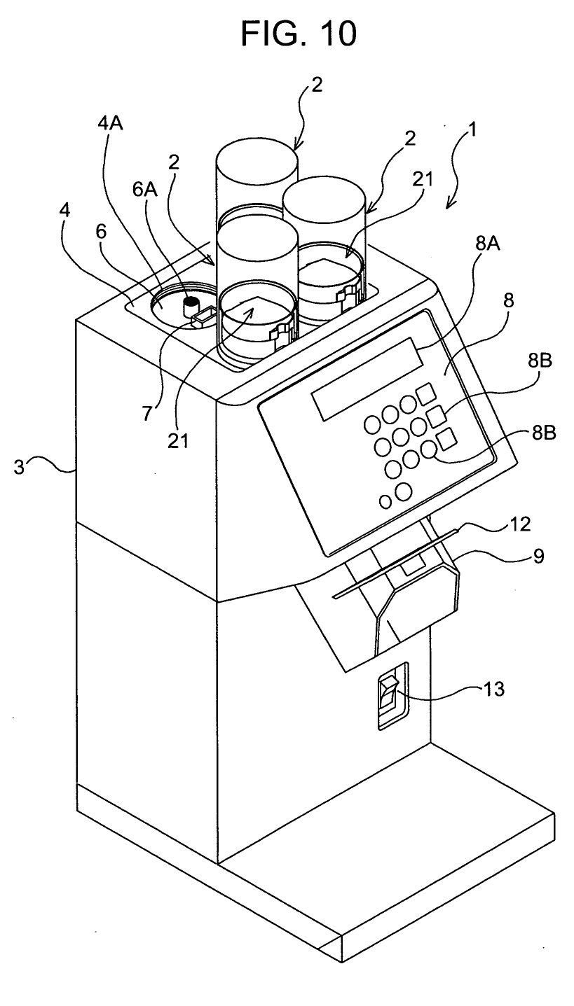

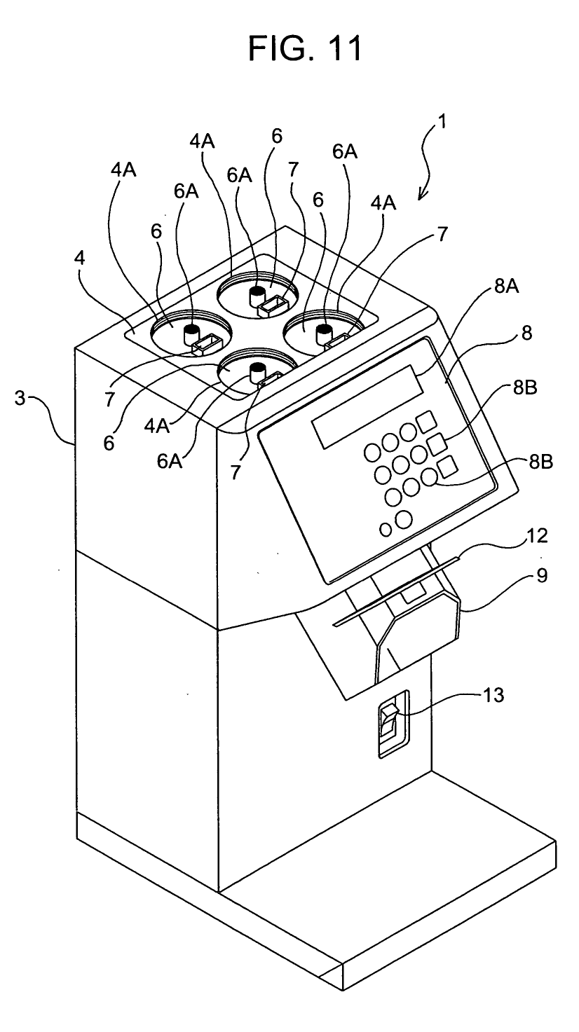

As illustrated in FIGS. 10 to 12, a medicine supply apparatus 1 of the present invention comprises a mounting portion 4 for detachably mounting tablet cases 2 . . . , in total of four, on the top side of a main body 3. The mounting portion 4 has four circular concave portions 4A each receiving one of the tablet cases 2 . . . detachably fitted therein. At the center of each concave portion 4A, there projects a rotation shaft 6A of a drive mechanism 6 in the form of an electric motor. A chute 7 is formed in each concave portion 7 for allowing a medicine to drop therethrough. Each chute 7 is mounted with an optical sensor (not shown) for detecting a dropping medicine.

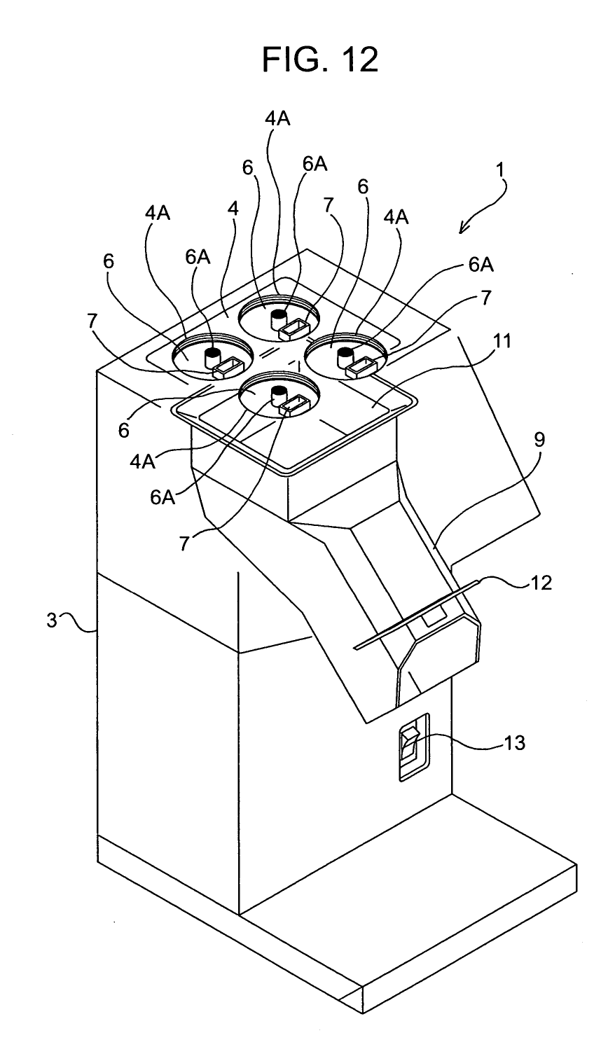

The main body 3 has a front upper portion projecting forward to have thereon a control panel 8 facing obliquely upward. The control panel 8 is provided with a display portion 8A and input keys 8A . . . . Under the control panel 8 is provided a nozzle 9 projecting obliquely downward and forward. As illustrated in a see-through perspective view of FIG. 12, an upper end of the nozzle 9 is continuous with a hopper 11 provided under the mounting portion 4 correspondingly thereto. The hopper 11 and the nozzle 9 conjointly form a filling member.

The chutes 7 . . . of the concave portions 4A . . . communicate with the hopper 11, respectively. A lower end of the nozzle 9 is open, and a shutter 12 is openably disposed on a slightly upper side of this opening for temporarily holding a medicine. Incidentally, numeral 13 is a power switch of the medicine supply apparatus 1.

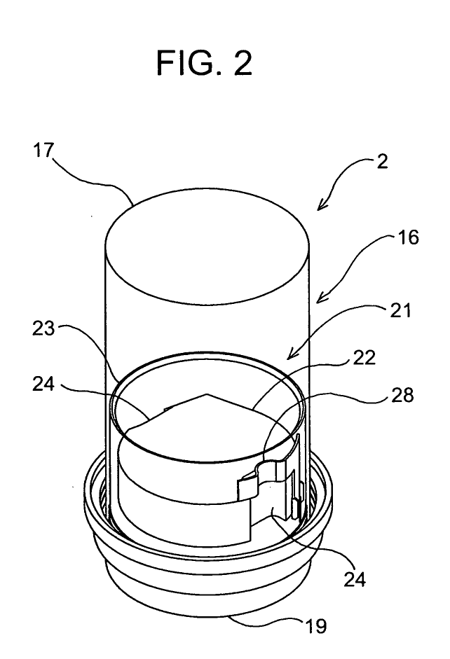

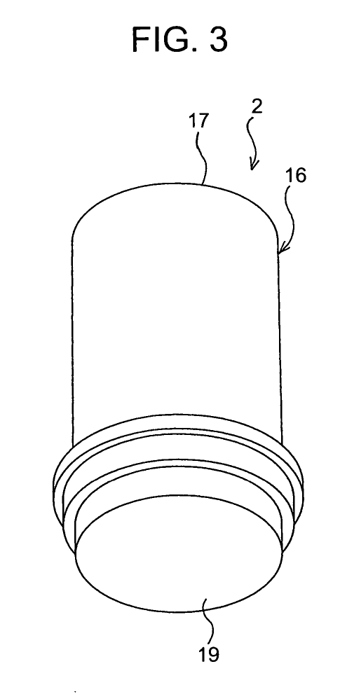

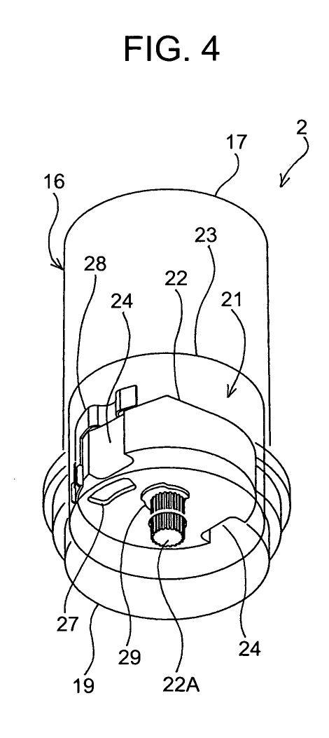

On the other hand, each tablet case 2 of the present invention is formed by a medicine container 16 made of hard synthetic resin. The medicine container 16 is, for example, a container containing medicines directly delivered to a hospital or pharmacy, or a taker from a medicine delivery company, or a container containing medicines offered in a hospital or pharmacy. FIGS. 2 and 3 each illustrate an upside-down state of the medicine container 16. The medicine container 16 comprises a semitransparent container body 17 of hard synthetic resin having a bottomed cylindrical shape, and a cover member 19 of hard synthetic resin that openably closes an opening 18 at one end (upper end) of the container body 17 for sealing the inside of the container body 17. Inasmuch as the medicines are delivered or offered while they are filled and contained in the container body 17, the container body 17 serves as a medicine containing portion of the tablet case 2.

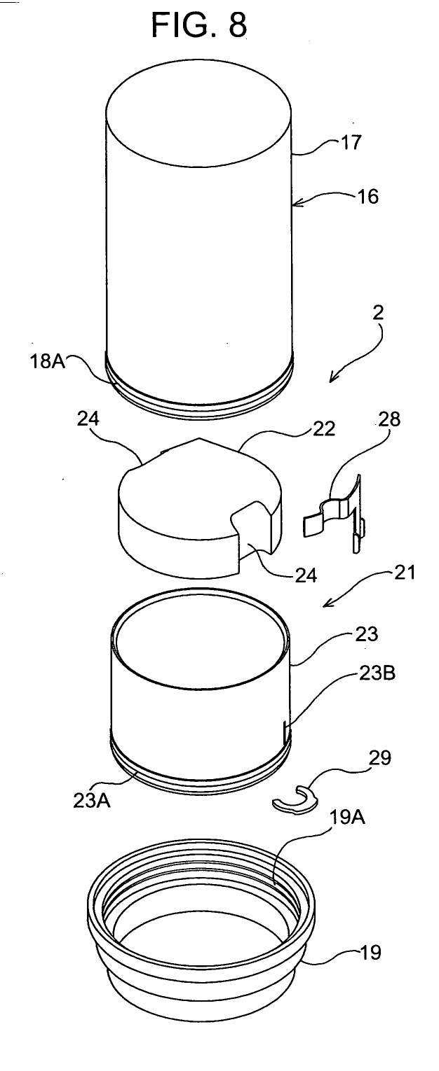

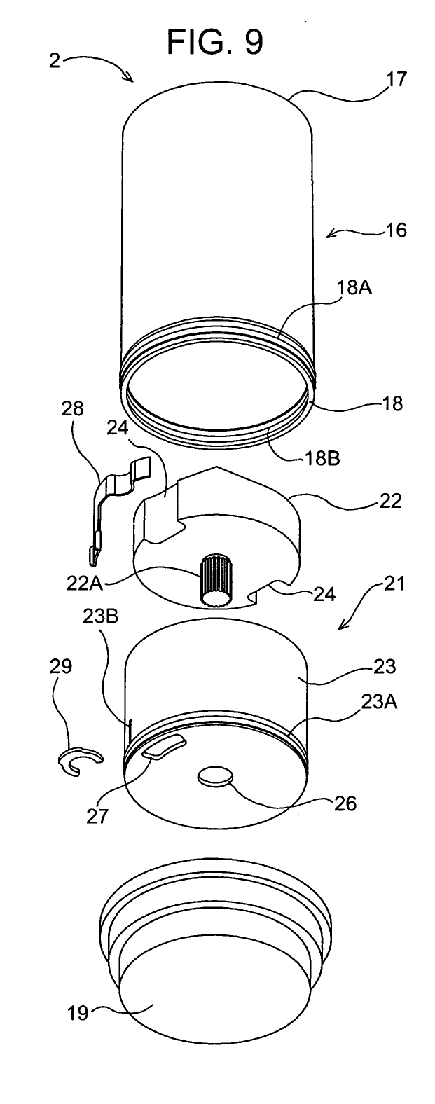

A thread groove 18A is formed on an outer edge portion of the opening 18 of the container body 17 as illustrated in FIGS. 8 and 9, and further, a thread groove 18B is formed also on an inner edge portion thereof as illustrated in FIG. 9. Similarly, a thread groove 19A is formed also on an inner circumference of the cover member 19 as illustrated in FIG. 8. By screw-engaging the thread groove 19A with the thread groove 18A of the container body 17, the cover member 19 is detachably attached to the container body 17 to thereby seal the inside of the container body 17.

For allowing the medicine container 16 to serve as the tablet case 2, the medicine container 16 is used in the upside-down state (i.e. the opening 18 is located on the bottom side) as illustrated in the respective figures. On the other hand, in FIG. 2, numeral 21 represents a discharge mechanism. The discharge mechanism 21 comprises a discharge drum 22 having an upper surface that is high at its center and inclined downward therefrom toward its peripheral edge, and a partition member 23 having a bottomed cylindrical shape and rotatably receiving therein the discharge drum 22. The discharge drum 22 has a side surface formed thereon with a plurality of grooves 24 (in this embodiment, two grooves 24 at confronting positions) each extending vertically. Further, the discharge drum 22 has a connecting shaft 22A projecting from its lower surface at the center thereof.

The partition member 23 has a bottom wall formed at its center with a through hole 26 through which the connecting shaft 22A of the discharge drum 22 rotatably passes, and further formed with a discharge port 27 at its peripheral portion. A thread groove 23A is further formed on a circumferential side wall of the partition member 23 at its lower end. Moreover, numeral 28 denotes an inhibiting plate formed by bending a metal plate, which is attached to a cutout 23B formed in the side wall of the partition member 23.

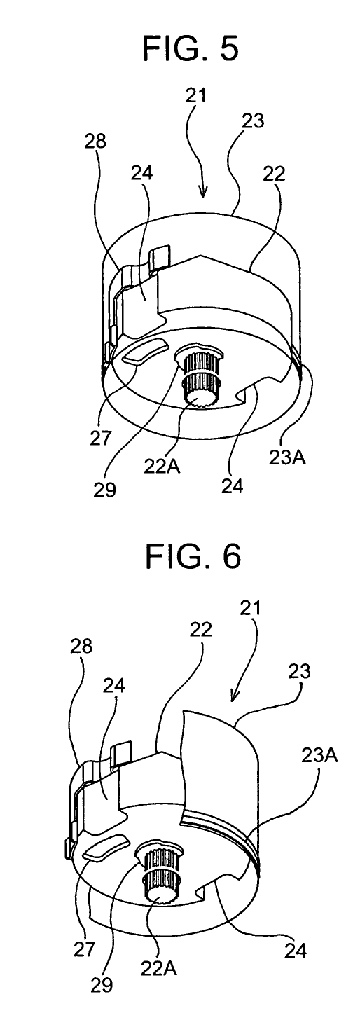

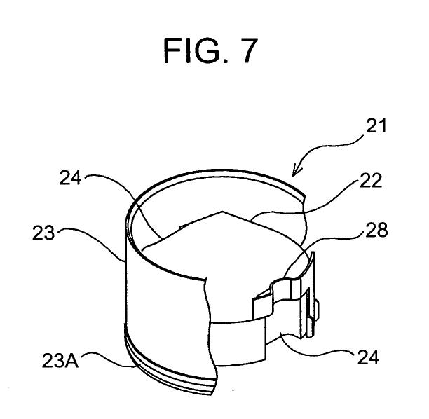

Upon assembling the discharge mechanism 21, the discharge drum 22 is first placed into the partition member 23 from above so as to be rotatable, with the connecting shaft 22A projecting downward through the through hole 26. Then, a washer 29 is mounted on the connecting shaft 22A to thereby prevent coming-off of the connecting shaft 22A. Then, the inhibiting plate 28 is attached to the cutout 23B. In this state, as illustrated in FIGS. 5 to 7, the inhibiting plate 28 is located at the peripheral edge of the upper surface of the discharge drum 22 at a position right above the discharge port 27. Further, the discharge port 27 is formed at a position corresponding to a lower side of each groove 24 of the discharge drum 22 when rotated.

The discharge mechanism 21 thus assembled is attached to the container body 17. Thereupon, the cover member 19 is first removed in the state where the opening 18 of the container body 17 containing the medicines is located on the top side. Then, the discharge mechanism 21, facing downward, is inserted into the container body 17 through the opening 18. Subsequently, the thread groove 23A of the partition member 23 is screw-engaged with the thread groove 18B formed on the inner edge portion of the container body 17. Accordingly, the discharge mechanism 21 is detachably mounted within the container body 17 so as to close the opening 18 of the container body 17. In this mounted state, the bottom surface of the partition member 23 is substantially on the same level with the opening 18, with only the discharge portion 27 being open. In this manner, the tablet case 2 is assembled.

Upon supplementing medicines into the container body 17 of the tablet case 2, since the opening 18 is made free by detaching the discharge mechanism 21, it is possible to easily fill up the medicines without hindrance. Further, the connecting shaft 22A projecting from the partition member 23 in the mounted state is set to a size that can be received within the cover member 19. Therefore, the cover member 19 is attachable to the thread groove 18A of the container body 17 in such a mounted state.

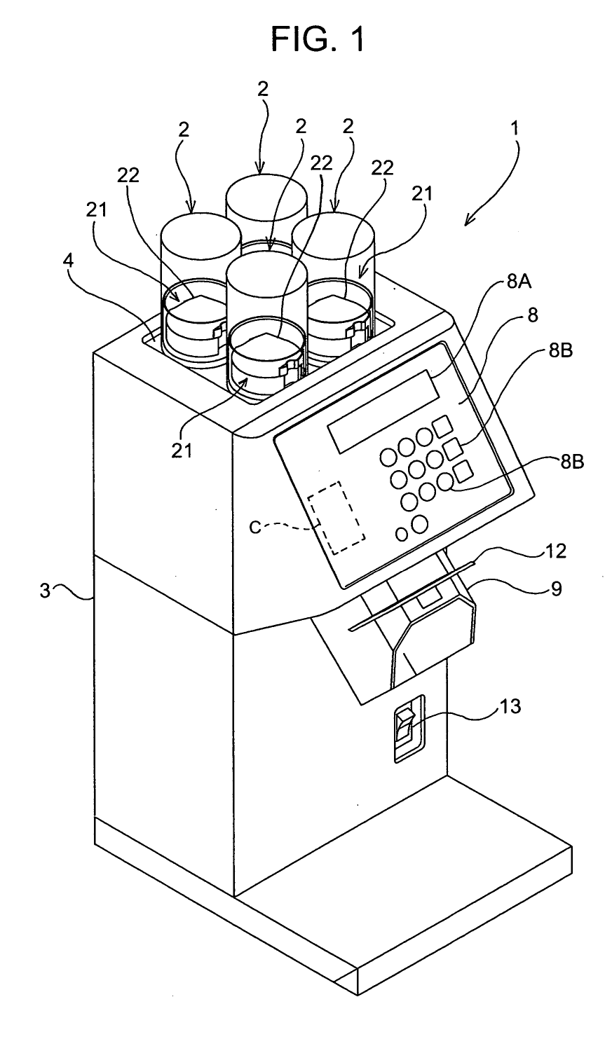

Then, upon mounting the tablet case 2 onto the medicine supply apparatus 1, the tablet case 2 is detachably fitted into one of the concave portions 4A . . . of the mounting portion 4, with the side of the discharge mechanism 21 (the side of the opening 18) facing downward. In this event, the connecting shaft 22A of the discharge drum 22 is detachably coupled to the rotation shaft 6A of the drive mechanism 6. Further, the discharge port 27 is located at a position corresponding to an upper edge of the corresponding chute 7 so as to communicate therewith. In this manner, the tablet cases 2, in total of four, are attached to the concave portions 4A, respectively, as illustrated in FIG. 1.

Then, using the input keys 8B, a position of each tablet case 2 (a position of each concave portion 4A) based on a kind of medicine is stored into a controller C (see FIG. 1) in the form of a general purpose microcomputer provided on the back of the control panel 8. Based on this position information, the controller C judges the kind of medicine and the position in the mounting portion 4 of the tablet case 2 containing such medicines.

The input of such position information may be automated. Specifically, a barcode identifying medicines and a containing amount thereof is normally stuck on the outer periphery of the container body 17 of each medicine container 16. Therefore, if a reader for reading this barcode is provided at each concave portion 4A, the position information of each tablet case 2 can be set in the controller C by reading the barcode using the reader when the corresponding tablet case 2 is mounted.

With this configuration, upon supplying medicines, prescription data from a doctor is first inputted using the input keys 8B of the control panel 8. Incidentally, the input of this prescription data may also be carried out by the use of a barcode reader, a memory card, a magnetic card, or the like. The controller C drives the drive mechanism 6 corresponding to the tablet case 2 containing the medicines according to the inputted prescription data to rotate the discharge drum 22 of the discharge mechanism 21 via the rotation shaft 6A and the connecting shaft 22A.

Herein, the side wall of the discharge drum 22 is formed with the grooves 24 as described before, and only one of the medicines in the container body 17 is put in each groove 24. Then, when the discharge drum 22 is rotated so that the groove 24 coincides with the discharge port 27 of the partition member 23, the medicine in the groove 24 drops into the chute 7 through the discharge port 27. In this event, since the inhibiting plate 28 is located on an upper side of the groove 24, the medicines on the discharge drum 22 are prevented from entering the groove 24. Consequently, inconvenience of discharging two medicines at one time can be avoided.

The medicine having dropped into the chute 7 is detected by the foregoing optical sensor, and the controller C counts the medicines discharged from the tablet case 2 based on the detection by the optical sensor. The medicine having dropped into the chute 7 in this manner drops into the hopper 11 located under the chutes 7 so as to be received therein, and then drops into the nozzle 9. The medicine having dropped into the nozzle 9 is retained within the nozzle 9 by the shutter 12. The controller C discharges required numbers and kinds of medicines from the tablet cases 2 . . . in this manner, then stops the drive mechanisms 6.

A user opens the shutter 12 to drop the medicines retained in the nozzle 9 from its lower end, and receives them using a vial or bag, or a hand.

On the other hand, the tablet case 2 containing medicines not used (not taken) by the foregoing prescription data is kept while it is detached from the mounting portion 4. In this event, if the thread groove 19A of the cover member 19 is screw-engaged with the thread groove 18A of the container body 17 to close the opening 18, the inside of the medicine containing portion (the container body 17) of the tablet case 2 is sealed with the cover member 19. Therefore, while the medicines not used are kept in the tablet case 2, it is possible to prevent the inconvenience wherein the medicines in the tablet case 2 are changed in quality due to moisture.

Incidentally, if the medicine supply apparatus 1 of the present invention is installed at home, automatic supply of medicines is made possible at home of a taker. Thereupon, the taker inputs prescription data like prescription data directed to a medicine delivery dealer from a hospital or pharmacy, into the controller C of the medicine supply apparatus 1 according to the method as described above, attaches the discharge mechanisms 21 to the medicine containers 16 delivered from the delivery dealer, and mounts them on the mounting portion 4 of the medicine supply apparatus 1.

If taking time zones are also set in the prescription data inputted into the controller C, medicines to be taken can be discharged into the nozzle 9 at predetermined times (morning, noon, evening, bedtime, etc.) by the controller C. This makes it possible to securely avoid occurrence of erroneous taking. Further, if the controller C has a communication function, automatic supply of medicines at home becomes possible by delivering prescription data from a hospital or the like using telephone lines.

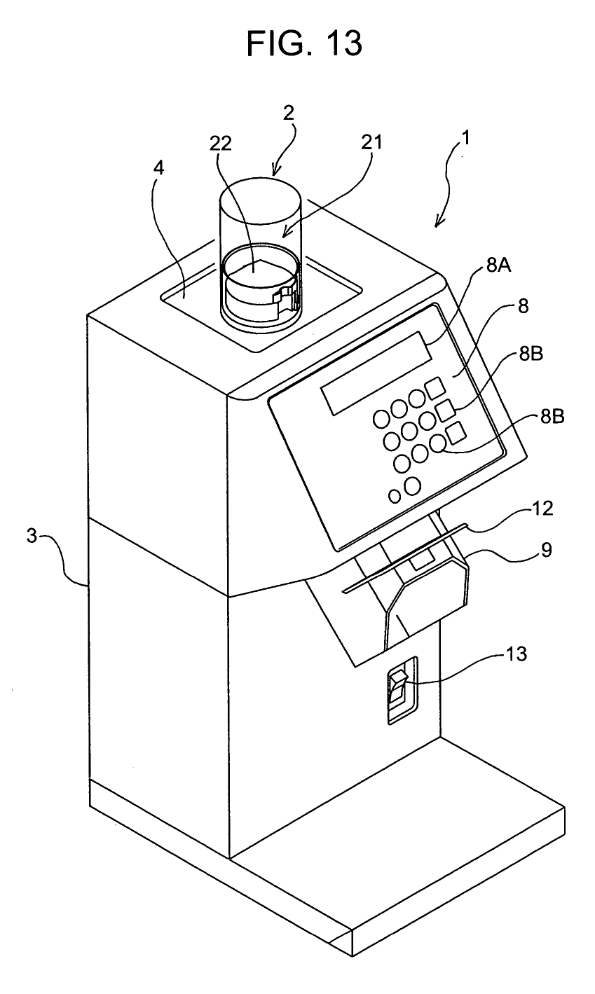

In the foregoing embodiment, the description has been made of the medicine supply apparatus 1 wherein the four tablet cases 2 can be mounted. However, only one tablet case 2 may be mounted as shown in FIG. 13, or five or more tablet cases 2 may be mounted.

As described above in detail, the medicine supply apparatus of the present invention comprises the tablet case having the opening, the discharge mechanism for dropping the medicine in the tablet case through the opening so as to be discharged, the drive mechanism for driving the discharge mechanism, and the filling member for receiving the medicine discharged by the discharge mechanism, wherein the opening of the tablet case is closed by the detachable cover member to enable sealing the inside of the tablet case. Therefore, when the tablet case is not used, it is possible to close the opening of the tablet case by the use of the cover member to keep the tablet case while sealing the inside thereof. This makes it possible to effectively prevent the quality of the medicines contained in the tablet case from changing due to moisture.

Further, the discharge mechanism is provided within the tablet case, and the drive mechanism drives the discharge mechanism in the state where the tablet case is detachably mounted on the mounting portion. Therefore, it is possible to smoothly discharge the medicine in the tablet case by the discharge mechanism, and receive and supply it by the filling member.

Further, the discharge mechanism is detachably mounted in the tablet case. Therefore, upon supplementing medicines into the tablet case through the opening thereof, the medicines can be filled up by removing the discharge mechanism. This makes it possible to easily fill the medicines into the tablet case.

Further, the tablet case of the present invention comprises the medicine containing portion having the opening and containing the medicines, the discharge mechanism provided in the medicine containing portion for dropping the medicine in the medicine containing portion through the opening thereof so as to be discharged, and the detachable cover member closing the opening of the medicine containing portion to seal the inside of the medicine containing portion. Therefore, when the tablet case is not used, it is possible to close the opening of the tablet case by the use of the cover member to keep the tablet case while sealing the inside thereof. This makes it possible to effectively prevent the quality of the medicines contained in the tablet case from changing due to moisture.

Further, the discharge mechanism is detachably mounted in the medicine containing portion. Therefore, upon supplementing medicines into the tablet case through the opening thereof, the medicines can be filled up by removing the discharge mechanism. This makes it possible to easily fill the medicines into the tablet case.

Further, according to the present invention, in the medicine container wherein the opening of the container body containing the medicines is closed and sealed by the detachable cover member, the discharge mechanism for dropping the medicine contained in the container body through the opening thereof so as to be discharged, can be detachably attached in the container body. Therefore, by forming the tablet case using the medicine container and mounting it onto the mounting portion of the medicine supply apparatus, the medicine in the container body can be discharged by the discharge mechanism. This enables medicine supply without using a particular tablet case.

Since the opening of the container body can be sealed with the cover member, when it is not used, it is possible to effectively prevent the quality of the medicines contained therein from changing due to moisture by closing the opening of the container body using the cover member.

Further, since the opening of the container body can be closed by the cover member in the state where the discharge mechanism is attached, when it is not used, it is possible to seal the inside of the container body with the cover member while the discharge mechanism is attached, and therefore, usage thereof is improved.

1. A medicine supply apparatus comprising:
a tablet case having an opening;
a discharge mechanism for dropping a medicine in said tablet case through said opening so as to be discharged;
a drive mechanism for driving said discharge mechanism; and
a filling member for receiving the medicine discharged by said discharge mechanism,
wherein said opening of the tablet case is closed by a detachable cover member to enable sealing the inside of said tablet case.

2. A medicine supply apparatus according to claim 1, wherein said discharge mechanism is provided in said tablet case, and said drive mechanism drives said discharge mechanism in the state where said tablet case is detachably mounted on a mounting portion.

3. A medicine supply apparatus according to claim 2, wherein said discharge mechanism is detachably attached in said tablet case.

4. A tablet case comprising:
a medicine containing portion having an opening and containing medicines;
a discharge mechanism provided in said medicine containing portion for dropping the medicine in said medicine containing portion through said opening so as to be discharged; and
a detachable cover member closing said opening of the medicine containing portion to seal the inside of said medicine containing portion.

5. A tablet case according to claim 4, wherein said discharge mechanism is detachably attached in said medicine containing portion.

6. A medicine container in which a container body containing medicines has an opening that is closed and sealed by a detachable cover member, wherein a discharge mechanism for dropping the medicine contained in said container body through said opening so as to be discharged, can be detachably attached in said container body.

7. A medicine container according to claim 6, wherein said opening of the container body can be closed by said cover member in the state where said discharge mechanism is attached.

8. A medicine supply apparatus using the medicine container according to claim 6 or 7, comprising:
a mounting portion where said container body with said discharge mechanism being attached is detachably mounted;
a drive mechanism for driving said discharge mechanism in the state where said container body is mounted on said mounting portion; and
a filling member for receiving the medicine discharged by said discharge mechanism.

9. A medicine supply apparatus using the medicine container according to claim 7, comprising:
a mounting portion where said container body with said discharge mechanism being attached is detachably mounted;
a drive mechanism for driving said discharge mechanism in the state where said container body is mounted on said mounting portion; and
a filling member for receiving the medicine the medicine discharged by said discharge mechanism.
